(19) United States
(12) Patent Application Publication
(10) Pub. No.: US 2011/0321055 A1
(43) Pub. Date: Dec. 29, 2011

(54) TRANSPORTATION ASSET MANAGER

(75) Inventors: Charles C. Moore, Plano, TX (US); John Hurlbert, Garland, TX (US); Scott D. Constien, Plano, TX (US); Craig Priest, (US)

(73) Assignee: Enfora, Inc., Richardson, TX (US)

(21) Appl. No.: 13/153,206

(22) Filed: Jun. 3, 2011

Related U.S. Application Data
(60) Provisional application No. 61/351,702, filed on Jun. 4, 2010.

(51) Int. Cl. G06F 9/46

(52) U.S. Cl. 718/104

(57) ABSTRACT

Systems and methods of visualizing assets are disclosed that include registering assets into a system, creating a correlation between the location of the assets and a physical representation of the operational area, determining the status and class of the assets, selecting at least one asset, and exerting control over the at least one asset.

### CROSS-REFERENCE TO RELATED APPLICATION(S) AND CLAIM OF PRIORITY

The present application hereby claims priority under U.S.C. §119(e) to U.S. Provisional Patent Application No. 61/351,702, filed Jun. 4, 2010, entitled “TRANSPORTATION ASSET MANAGER,” and is hereby incorporated by reference into the present application as if fully set forth herein.

### TECHNICAL FIELD

Generally, the invention relates to the allocation and control of assets, and more particularly, to the allocation and control of mobile assets in a dynamic environment.

### BACKGROUND

Allocation of assets in a dynamic environment poses a number of unique and novel problems. These problems include decisions relating to minimizing cost, while optimizing usage of assets within the dynamic environment.

For instance, in the transportation industry, the allocation of which assets are to carry which products is difficult for a number of reasons. First, the information required prior to the allocation of any particular asset may not be known until just prior to the deployment of the asset. In addition, the availability, capability or status of a particular asset may not be known until just prior to the need to deploy that asset. Finally, an asset that may be used to perform a particular function may not be under the direct control or supervision of an operator that requires the use of the asset.

Therefore, systems and methods that can optimize the allocation of assets in a dynamic operational environment are needed.

### SUMMARY

In one embodiment there is provided an asset allocation management system. The system includes an asset located within an operational area and an asset management system in communication with the asset. The asset management system is configured to determine that the asset has entered the operational area and the asset is capable of performing one or more requested services, and the asset management system obtains control of capabilities of the asset.

In another embodiment, there is a method for asset management. The method includes determining that a plurality of assets are within the control of an operator, wherein at least one of the assets is not owned by the operator; obtaining a request for a task that can be completed by at least one of the assets; determining which of the plurality of assets are cable of performing the task; selecting one of the determined asset(s) based upon at least one parameter; and assigning the selected asset to perform the task.

In yet another embodiment, there is provided a method of visualizing assets for management. The method includes registering a plurality of assets in a visual asset system; identifying an operational task which can be satisfied using at least one of the plurality of assets; determining a status of at least one of the plurality of the assets; determining a class of at least one of the plurality of assets; selecting at least one of the plurality of the assets based upon the status and class of the at least one of the plurality of the assets which can complete the operational task; and exerting control over the at least one of the plurality of the assets.

### BRIEF DESCRIPTION OF THE DRAWINGS

FIG. 1 is a simplified overview of one system using a transport asset management (TAM) system according to one embodiment of the present disclosure;

FIG. 2 is a simplified overview of a second system using the transport asset management (TAM) system according to one embodiment of the present disclosure;

FIG. 3 is a simplified overview of a third system using the transport asset management (TAM) system according to one embodiment of the present disclosure;

FIG. 4 is a flowchart illustrating one method of allocating assets to services according to one embodiment of the present disclosure;

FIG. 5 is an example of a table illustrating the storage of available assets according to one embodiment of the present disclosure;

FIG. 6 is an example of a table including additional information relating to a class of assets;

FIG. 7 is a flowchart illustrating one method of determining assignment of assets) to service(s); and

FIG. 8 is a block diagram of one system capable of being used with the present systems and methods.

### DETAILED DESCRIPTION

Traditional methods of allocating assets in a dynamic environment have suffered from a number of different problems. These problems have created inefficiencies within the system which inhibit the optimal allocation of available assets. The transport asset management (TAM) system described herein overcomes these prior art problems by integrating a number of innovative software and hardware features that promote the efficient allocation of assets. The TAM system enables the efficient allocation of a variety of different assets to complete a plurality of different services.

One problem with the allocation of assets in the prior art is that there exists no way to efficiently allocate assets to perform the plurality of services. Real-time information regarding the status, location and capability of assets has been unavailable. Moreover, tools that could use real-time information to optimally allocate available assets have not been made available.

The scope of this problem continues to increase. As assets become more intelligent, have greater capabilities, and have more access to communications channels, the challenges of this environment are expected increase.

The TAM system allows an operator to control a number of assets within a predefined area, irrespective of ownership of the asset. One of the innovative advantages of the TAM system is that it does not require ownership of an asset in order to exert control over the asset. The innovative model of control without ownership allows for cooperative real-time sharing of assets without the user of the TAM system actually owning all of the available assets. In addition, the TAM system allows for back end control of operational cost by unifying individual assets into a pool that may be used to achieve the best allocation of assets. Finally, the TAM system allows for enhanced visualization of the allocation of assets.

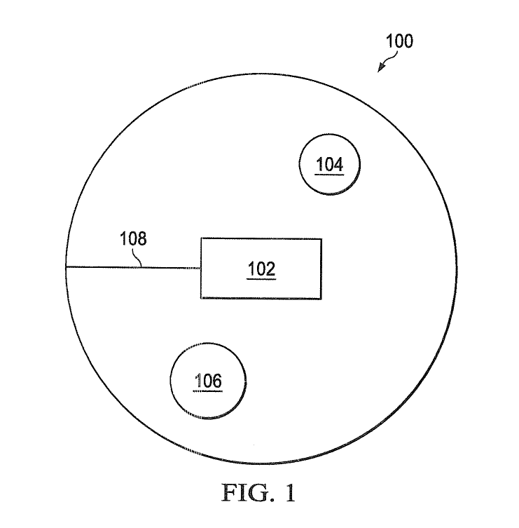

As shown in FIG. 1, one of the innovative elements of the TAM system. 100 is the ability to designate a boundary or operational “area” 108 and control of assets 104, 106 within the operational area 108. The TAM system 100 includes a controller 102 for asserting operational control when the asset 104, 106 enters the operational area 108.

In the example shown in FIG. 1, the operational area 108 is illustrated by a circle (e.g., a single GPS point and a radial distance from that point). In implementation, the operational area 108 can be defined in a variety of manners, including proximity to a predefined point (e.g. a specific shipyard), proximity to a temporary or mobile landmark (e.g. a cargo barge), within a specified geographic region (e.g. a shipyard or city), or a group of locations with shared attributes (e.g. hostile areas, manufacturing sites, or shipping locations). It is expressly understood that the operational area 108 can be defined by any number of points, with any relationship between the points, and may take many shapes.

For the purpose of clarity, it is understood that the assets described herein may be used for one or more different services or purposes. For example, these may include the transportation of goods and the performance of service(s) at a particular location, or any exertion of control over any asset for any purpose. The term “service” is further intended to be inclusive of any function that an asset may perform. These services may include performing repairs, providing transportation, or any other function that an asset may perform. Further, it will be understood that an “operator” is an entity that can exercise control of an asset by specifying the use of asset capabilities to perform a specific purpose or service. Examples include warehouse managers, dispatchers, maintenance personnel, manufacturers and shippers.

The term “asset” is intended to refer to a plurality of different types of assets, including containers, trucks, products, or any other item that are capable of performing a service. It is understood that assets can have a series of capabilities that provide both information for local action, and control/status information for operator access. These capabilities include, but are not limited to, location awareness, power awareness, application awareness, destination awareness, temperature awareness, acceleration awareness, time awareness, and sensor awareness.

Location awareness includes the ability to notify operators based upon areas being entered or exited. Examples of location awareness include transitioning into or out of a geofence (as determined by GPS functionality) or location (as determined other wireless transmitters).

Power awareness includes information related to power consumption or power availability to be used to take appropriate action. For instance, an operator may decrease polling of the asset in response to power failure or to low battery power.

Application awareness includes the ability of an operator to tailor behavior of all or part of the asset based upon the application that is currently being performed by the asset (transportation of produce, hazardous materials, etc.). For instance, if a hazardous material is being transported, additional sensors may be activated and polled to check the consistency or integrity of the containers transporting the hazardous material.

Destination awareness includes information that may be used to aid in the routing and delivery of a product.

Time awareness includes the ability of a controller to initiate or schedule time based events. Embodiments of time based events may be asset initiated or operator initiated. Asset initiated may be where an asset may change roles, ownership or other features at a predetermined time or time interval. Operator initiated may be where an operator may require asset reallocation at predetermined times or time intervals. In embodiments where a scheduled time event is programmed into an asset, the asset may change roles, ownership, or other feature at a predetermined time.

Temperature awareness includes the tracking of both internal and external temperatures. This tracking may be used to provide historical logs and real time notification of the asset environment. For instance, during the transportation of frozen materials, a notification may be sent to an asset upon the temperature exceeding a safe condition.

Acceleration awareness includes the monitoring of asset vibration, shock, tilting and acceleration for determining, measuring and reporting forces experienced by the asset. Acceleration awareness may be maintained through one or more sensors capable of determining the acceleration of an asset.

While temperature and acceleration are two examples of conditions or parameters which may be measured, it is expressly understood that additional sensors operable for measuring other conditions or parameters may be used consistent with the present disclosure. For example, sensors may be utilized for enabling the monitoring and control of generic inputs and outputs assigned to operator specific applications such as controlling pumps, doors, photosensors, air pressure transducers, compass transducers, or other devices.

In one embodiment, the TAM system 100 uses a plurality of wireless base stations enabled by any type of technology known by one skilled in the art to create a wireless network capable of communication with a plurality of assets. The TAM system 100 further may incorporate global positioning system (GPS) data or wireless network based location functionality to determine an operational area and positioning information.

The assertion of operational control by the controller 102 is made when that particular asset 104, 106 enters the defined operational area 108. This assertion is initiated by the asset using location awareness to determine entry into the operational area 108. Registration of a particular asset in the TAM system 100 (and to the controller 102) may be made in any way known to those skilled in the art. It is understood this registration process may take place using either an active or passive model. In an active model, the asset identifies itself as entering into the operational area controlled by the TAM system 100 and transmits a message to the controller 102 indicating the availability of the asset. In a passive model, the asset is continuously tracked by the TAM system 100 and no registration message is required. The selection of a particular model may be made either by the asset or by the TAM system 100.

In the active model, when the particular asset 104, 106 enters the operational area 108, the asset 104, 106 sends a registration message to the controller 102 indicating or alerting of the presence of the asset 104, 106. It is understood the registration message sent to the controller 102 may comprise additional information including information relating to capabilities, availability and location of the asset. Other messages may also be sent.

In the passive model, when the asset enters the operational area 108, that event is detected by the controller 102. The asset reports the status and availability to the controller 102 and is registered as an asset within the operational area 108.

In FIG. 1, the TAM system controller 102 controls the operational area 108 having the asset 104 therein. Once the asset 104 has registered, the TAM system controller 102 maintains or exercises control over the asset. This control occurs regardless of whether or not the TAM system 100 (user) owns the asset 104. For the purpose of clarity, “control” includes the controlling any capability of the asset 104. The allocation of “control” can include any subset of capabilities of the asset. This “control” without “ownership” model may allow a single operator to designate how and where the resource, or portions of the resource should be used regardless of ownership.

In addition to control based upon location awareness, control may also be based upon power awareness, application awareness, destination awareness, time awareness, or temperature awareness, or any combination of these.

In some embodiments, assets can send and receive configuration and control data to provide both immediate control and status, and to configure the asset to take actions based upon local events. For example, these actions may include notification, GPIO activation, or beaconing based upon specific events. Local events may be detected using asset resources, including but not limited to location awareness, power awareness, application awareness, destination awareness, time awareness, and temperature awareness.

The ability to take specific actions using specific events has several applications. For example, destination awareness information may provide routing assistance and notification of arrival to an operator. In one embodiment, upon the approach of an asset to a specific destination, the asset may be routed to a particular location or bay for unloading of cargo. In another embodiment, the asset may be routed around a construction site or other obstacle to the destination.

In another example, acceleration awareness may be used to provide information to a controller or the asset of movement or tilt. A warning may be given to the operator of the asset of the excess movement, tilt, or acceleration to give the operator an opportunity to adjust or correct. In other embodiments, the operator with control over the asset may remotely deactivate the engine or other component of the asset to correct acceleration or movement.

In yet another example, systems and methods may be used to detect temperature extremes allowing for the potential prevention of damage to cargo. This temperature may be due to a variety of causes (faulty hardware, operator error, a door to a freezer left open, etc.). This notification may allow the controller of the asset to take corrective action (notify the asset of the problem, alter the operation of refrigeration within the asset, etc.).

In the event of an asset's proximity to specified devices, other assets, or operators, appropriate notification and behavior modification can be provided (automatic tripping of alarms, automatic modification of reporting intervals, etc.).

An asset may be configured to accept control from a specified set (one or more) of operators. In addition, sets of operators may be restricted to specific functions. Examples of functions which may be limited include power, security, quality or shipping functions. For example, operators responsible for battery changes may be restricted to power status only, security personnel are provided prioritized access to hazardous materials, quality control personnel are restricted to temperature and acceleration history, and shipping personnel and manufacturers are allowed access to current location and destination configuration.

Operators can also be mobile, and control of assets can be passed to operators based upon proximity or some other device derived information. Examples of environments with this capability include situations in an operator retains control of specific assets until a designated operator enters the proximity of the asset. The original operator then relinquishes control. An additional example would be when a mobile operator has control of an asset and transfers ownership to another mobile operator (e.g., a train engine transferring control of a train car). A further example may be if a mobile operator enters a specified area, the asset is deposited to local control. The operator responsible for the area assumes control of the asset. A further example is if a temperature extreme is exceeded and control of an asset is transferred to support personnel that can address device specific issues.

Operators may be granted full or partial control of an asset. A centralized operator can allocate responsibility to multiple operators, each responsible for a subset of control. One example of this would be in a shipyard. One group of operators responsible for shipping would receive access to destination control, location information, and shipment status. Another group of managers for a region may be responsible for power, security and environmental control to receive access to power status, container security issues, temperature, and acceleration information. Similarly, shippers may be responsible for delivering an asset from an origination point to a destination point and receive access to location information and destination information.

In a different embodiment, operators can be grouped into functional entities. For example, a trucking company being labeled as a group of operators, with each having possession of a group of assets. In this embodiment, inventory control could be considered as the aggregation of all manufacturing facilities. A site manager could be responsible for management of a location, but access to specific subsets of capabilities could be allocated across all sites for limited access.

Areas can be grouped by common site attribute, based upon operator determined groupings, and managed as a single entity. One embodiment of this is when a group of locations is labeled as “hostile areas” (locations that stolen assets are typically stored), and responsibility passed to recovery teams or law enforcement. A second embodiment may be when a group of locations is labeled as a manufacturing site and placed under control of inventory management. A third embodiment may be when a group of locations is labeled as belonging to a specific shipping company and information regarding this site could be shared with the shipping company.

Assets can be grouped based upon operator determined groupings by a common asset: attribute. One embodiment of this is when assets hosting hazardous materials are placed under control of the security operation. A second embodiment may be when assets requiring temperature control are placed under control of a refrigeration control operator. A third embodiment may be when assets requiring periodic servicing (e.g., plants requiring water, fuel in generators, battery recharging) are placed under control of a maintenance operator.

Operators, areas, and assets can be allocated based upon a multidimensional, multilevel architecture. An embodiment of this is when a subset of operators responsible for watering plants are assigned control of maintenance of a subset of assets requiring water across multiple areas. A second embodiment may be when a subset of operators responsible for security are assigned responsibility for locations of a subset of assets requiring hazardous material classification across multiple areas. A third embodiment may be when a subset of products is monitored by a subset of assets (e.g., manufacturers) across multiple areas (e.g., United States). A fourth embodiment may be when all areas not specified by geofences are accessed by all assets not responsible for maintenance.

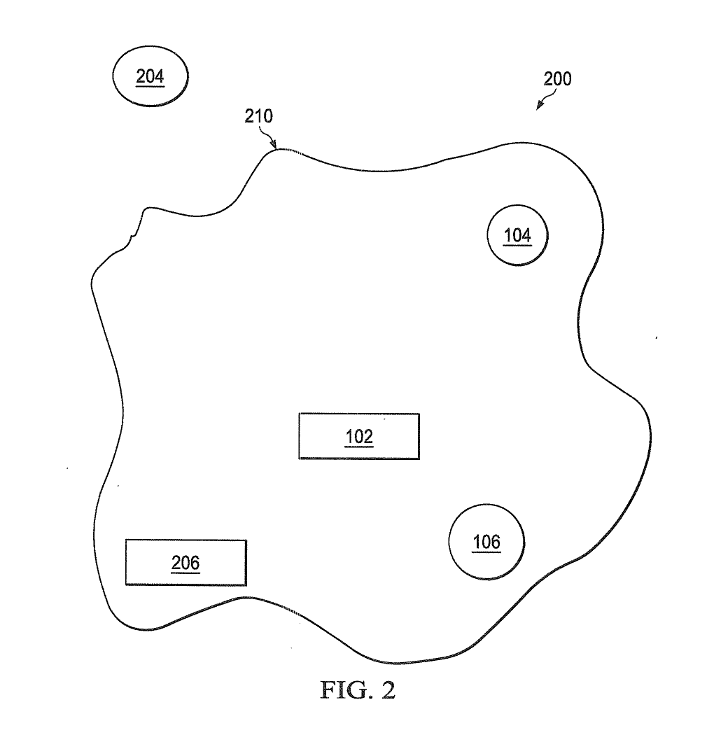

FIG. 2 is an example of a transport asset management (TAM) system 200 operated within an operational area 210 using a plurality of wireless transceivers. Located within the operational area 210 are assets 104, 106. The TAM system 200 also includes the controller 102 and a secondary controller 206. An asset 204 is shown located outside the operational area 210.

It will be understood that, for purposes of illustration, the asset 204 is not under the control of the TAM system 200. Though the TAM system 200 may be aware of the status and location of the asset 204, it may not exert control over the asset until the asset 204 enters the operational area 210. This approach allows for the TAM system 200 to be aware of assets in an extended region outside the operational area 210, even if those assets are not immediately available, and to have a secondary source of available assets. In essence, in the event a task request enters the TAM system 200 which cannot be met by available assets under control of the TAM system 200, the TAM system 200 may issue a request for an additional asset to be used that is not under control of the TAM system 200. In this way, the TAM system 200 has expandability to acquire other assets that are not directly under its control.

Another innovative element of the present disclosure is the ability to utilize a plurality of transceivers located anywhere—either within or outside of designated operational area—which track, communicate, and/or monitor assets within and outside the area. This enables differently sized and shaped operational areas to be monitored and controlled by a single transport asset management system. The transceivers may be configured at wireless cellular base stations, wireless transceivers, satellite communications links, and the like, or any other suitable technology which can be used for communication.

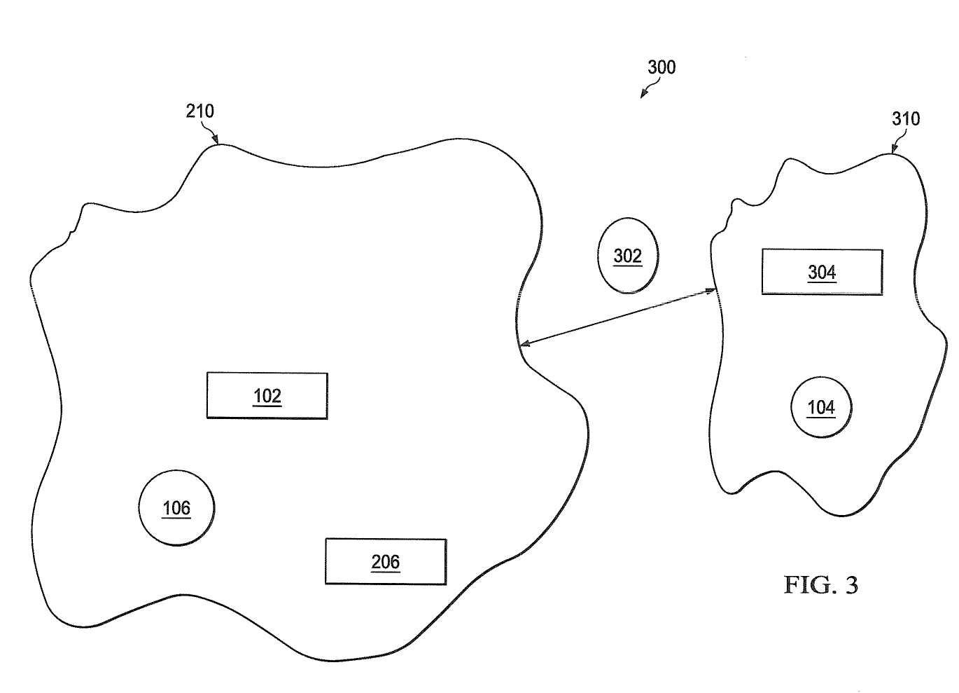

FIG. 3 illustrates a TAM system 300 having a plurality of different operational areas 210, 310 of different size/shape that may be used to control a number of different assets. One of the innovative elements of the present disclosure is the ability to use a plurality of controllers in order to control assets within a number of areas. In this example, the asset 106 within the area 210 is controlled by controller 102 and the asset 104 is controlled by controller 304.

In some applications, it may be necessary to instruct a particular asset to exit one operational area and enter a different operational area. An asset 302, in the example shown in FIG. 3, has been instructed to leave one operational area 210/310 and enter the other respective operational area 310/210. In one embodiment, the controller(s) may instruct a particular asset to leave one operational area and enter the second operational area. In such a case, control may switch from the controller 102/304 to the other respective controller 304/102.

Certain operational modes may give a special status to an asset as it enters an operational area. This status may include a “predispatched” status. For example, in the event a truck has a load to deliver to a site within the operational area of another TAM controller, the current TAM controller will be unable to give instructions to the truck until after the load has been delivered. In another example, in the event a service repair crew has been dispatched to perform a repair, until the repair is complete, a particular TAM controller may not exert control over the service repair crew. Other rules or modes may be implemented through the TAM system as may be required to promote the overall efficiency of the TAM system.

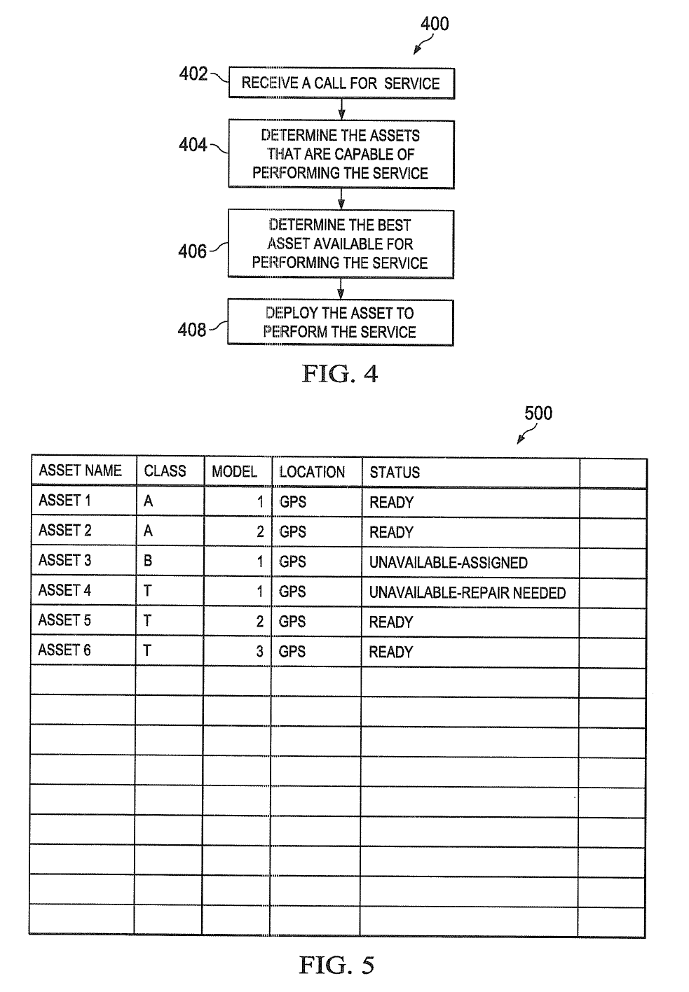

FIG. 4 is a flowchart illustrating a process 400 for allocating asset(s). A call is received requesting a particular service (block 402). A determination is made to identify all assets capable of performing the requested service (block 404). Of these assets, a determination is made identifying/selecting an asset to perform the requested service (block 406). Various factors know to those skilled in asset allocation may be considered. Thereafter, the selected asset is deployed and the service is performed. As will be appreciated, a requested service may include one or more services, and the selected asset may include one or more assets.

Now turning to FIG. 5, there is illustrated in table format a set of information that might be utilized with the TAM system. For example, the set of information may include asset name, class of the asset, and other fields that describe the asset.

It is understood that the name of the asset may be used as a unique field within the table. The class of the asset may be used to identify the type of service that the asset is capable of performing. For exemplary purposes, Class A will refer to a small truck asset designed to provide plumbing repair services, Class B will be used to designate a large truck asset designed to provide public utility repair services, and Class T will be used to designate transportation devices (such as a freight truck).

Another of the innovative elements of the present disclosure is the ability to allocate assets based only upon the class of the asset which is indicative of the type of service the asset may perform, or based on the actual operational abilities of the particular asset. This may be important in transportation applications since a plurality of assets may be used for transportation purposes but may have substantially different operational abilities.

For instance, a large truck and a small truck may both be used in order to transport an item, however, transporting large quantities may only be performed by a certain model of asset. The TAM controller takes into account not only the class of the asset, but the particular parameters relating to the particular asset. In this way the controller and system can accurately and optimally deploy assets into the field.

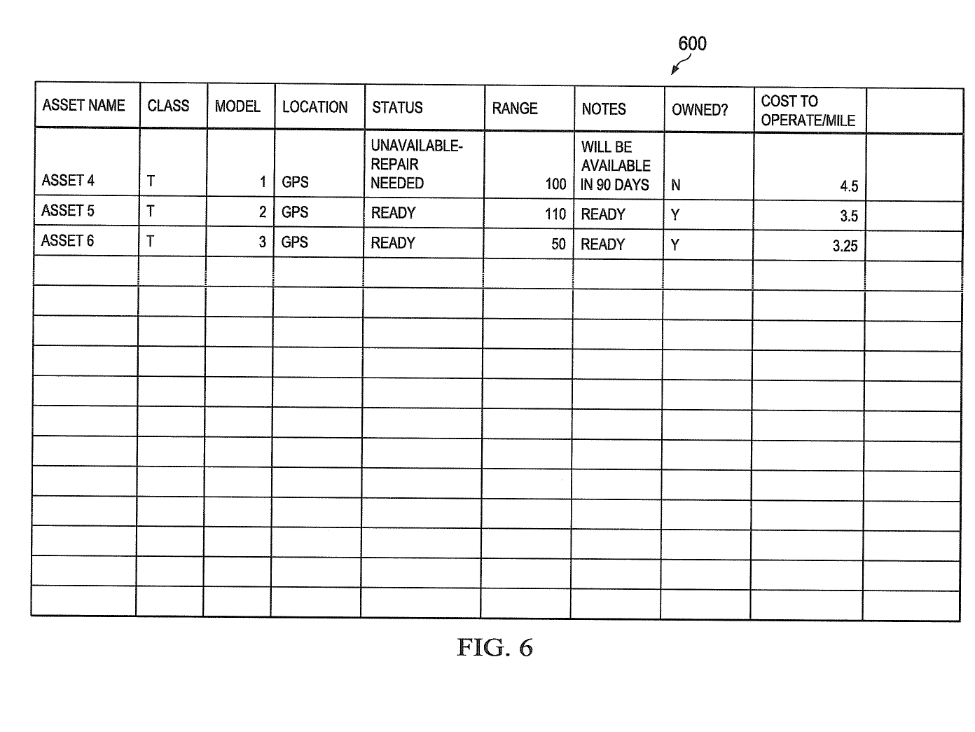

As illustrated in. FIG. 4, one of the steps in the allocation of particular assets is the determination of which assets may be used (capable) for a particular purpose. It will be understood that a subset of assets within a particular class of assets may have additional information about that subset of assets. For example, and turning to FIG. 6, additional information is given about each of the transportation assets (Assets 4, 5 and 6). This additional information may include (and is not limited to) status, range of the asset, notes relating to the asset, ownership, and the operational cost for transportation purposes. Some or all of this information may be used by a particular class of assets but not necessarily by every class of assets. In this way the databases are optimally configured to store only additional information that is relevant to that class of assets actually deployed for each asset within the database system.

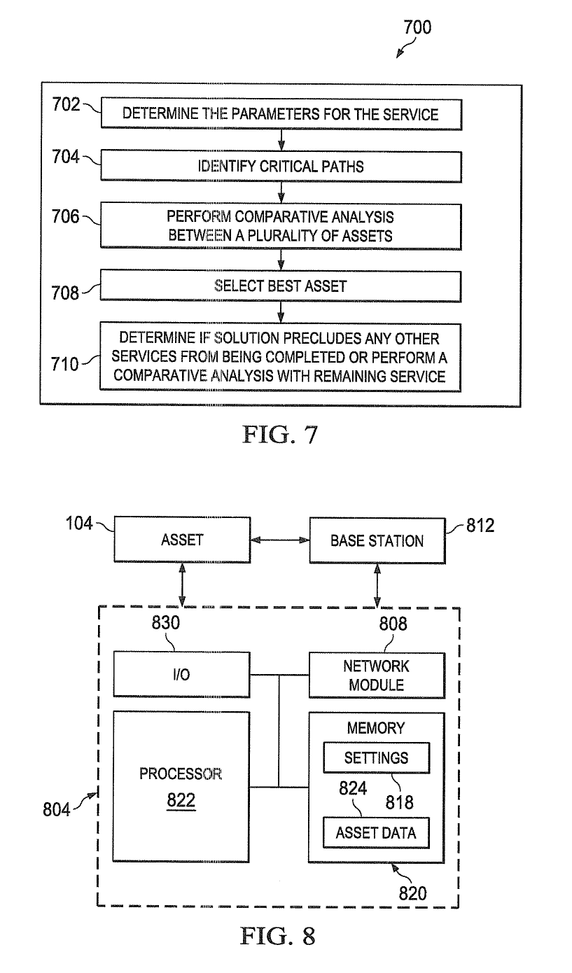

FIG. 7 is a flowchart illustrating a process 700 for determining/selecting an asset for the requested service. In block 702, there is a determination of the parameters or conditions necessary for the requested service (block 702). These parameters or conditions may include, for instance, the amount of fuel required for vehicle operation versus the cargo capability of the vehicle.

Next, critical paths are determined (block 704). A critical path may include timing problems, for instance, deadlines that must be met within the transportation schedule. These critical paths may also include, but are not necessarily limited to, additional information which may be stored within the TAM controller. On the subset of available assets able to perform the requested service, a comparative analysis is performed (block 706) and one asset is selected (bock 708). In this way, a determination may be made about which asset us best suited for a particular service/task based upon the relative cost of other assets also available to perform the request service/task (a discussion of determining the cost of an asset is set forth below).

Once an asset is selected, a determination may be made whether the solution selected may preclude completion or interfere with any other previously requested services. If such determination is made, the process may be restarted to select another asset (or use the second best asset) for the requested service.

The selection of the best asset for a particular service may be made based upon a determination of the total cost of the asset. For instance, the TAM controller may make a determination of the total cost of deploying a particular asset based upon the marginal cost for use of an asset and compare this with the total cost of a second asset. The total cost associated with the ownership of asset, as well as other factors that affect the total cost of the asset, may be considered. For instance, for a transportation asset, the total cost for the asset may be the sum of the cost to operate the asset per mile, plus the costs already associated with the asset. These associated costs may include, but are not limited to, whether the TAM system owns the asset.

Another one of the innovative elements of the present disclosure is the ability to allocate assets based on the current position of the assets. One problem that may be encountered in the prior art method(s) of allocating assets for a particular service is that the precise location of the asset may not be known while planning to allocate the assets at a particular time. The present system overcomes this by allowing the TAM system to combine real-time information related to the location/position and status of the assets with the status of a plurality of requested services which require completion. By combining these two elements, a small allocation of resources may be made to perform a plurality of services within a plurality of separate classes.

One of the advantages of the present disclosure is the ability to take into consideration the ownership of an asset and costs of utilizing an asset. For instance, if a light truck is needed for s service/task, and the operator only has access to a heavy truck, it may be more cost effective to use a contractor not owned by the operator to perform the service/task.

In one embodiment, the TAM system 100 may be operated by a trucking company or by a pool of companies. In the pool example, no assets are owned by operator(S) of the TAM system 100, while in the trucking company example, some or all of the assets may be owned by trucking company (the operator of the TAM).

Data available to the TAM system 100 may be displayed to the operator to provide a visual representation of the location of each asset within the operational area. In addition, it will be understood that additional visual representations (colors, icons, flashing, etc.) may further provide other information regarding the status, class, etc. regarding each asset within the operational area. As described below, class indicates the capabilities of the asset, and status indicates the current operational state of the asset. For example, an asset that is available for assignment to particular service may be colored in green. An asset which has been assigned to a particular service may be colored in blue. An asset that is out of service may be colored in red. The assignment of a color may be made based upon a plurality of different conditions. For instance, an asset which is both available but not owned by the operator of the TAM system 100 may be colored in purple. The examples of colors are given for exemplary purposes only.

Other visual representations may be utilized. For instance, an asset that is flashing a certain color may be in the process of being taken control of. In another instance, an asset that is flashing another color may indicate an alert condition (equipment failure, leaving of a geofence, unauthorized access to cargo, etc.). Therefore, the map may simultaneously display class, status, ownership, etc. of the assets.

The TAM system 100 described above may be implemented on any computer system with sufficient processing power, memory resources, and network throughput capability to handle the necessary workload placed upon it. FIG. 8 illustrates a typical computer or computer system 804 suitable for implementing one or more embodiments disclosed herein.

The computer system 804 includes a processor 822 (which may be referred to as a central processor unit or CPU, and implemented as one or more CPUs) in communication with memory 820 (that may include one or more of the many different types of memory, such as read only memory (ROM), flash, random access memory (RAM), and the like). The computer system 804 further includes input/output (I/O) device(s) 830 and a network connectivity module 808 (with one or more network interface devices).

Secondary storage (not shown) may also be included and typically includes one or more disk or tape drives and are used for non-volatile storage of data and as an over-flow data storage device if the memory 804 is not large enough to hold all working data. In addition, secondary storage may be used to store certain programs that are loaded into memory 820 when such programs are selected for execution, while memory 820 may be used to store instructions and perhaps data that are read during program execution.

The I/O device(s) 830 may include printers, displays (monitors, liquid crystal displays (LCDs), touch screen displays), keyboards, keypads, switches, dials, mice, track balls, voice recognizers, card readers, paper tape readers, or other well-known input devices. The network module 808 and network devices may take the form of modems, modem banks, Ethernet cards, universal serial bus (USE) interface cards, serial interfaces, token ring cards, fiber distributed data interface (FDDI) cards, wireless local area network (WLAN) cards, radio transceiver cards such as code division multiple access (CDMA) and/or global system for mobile communications (GSM) radio transceiver cards, and other well-known network devices. These network devices 808 may enable the processor 822 to communicate with an Internet or one or more intranets. With such a network connection, it is contemplated that the processor 822 will receive/transmit information from/to a network in the course of performing the above-described method steps. Such information, which is often represented as a sequence of instructions to be executed using processor 822, may be received from and outputted to the network, for example, in the form of a computer data signal embodied in a carrier wave.

The memory 820 may store one or more settings 818 and a routing table 824. Settings 818 may be used to store elements relating to the configuration of the TAM system 100. These elements include, but are not limited to, the definitions of classes and types for assets as well as other information used the allocation of assets.

The TAM system 100 may also include various remote communications devices, such as one or more base stations 812. The TAM system 100 may further include any number of other connections to other systems and networks.

The network module 808 may include wireless communication capabilities to provide wireless communication functionality between the TAM system 100 and the base station 812 and/or a remote device such as a host server (not shown). The network module 808 in the TAM system 100 may utilize any wireless technology including, but not limited to, code division multiple access (CDMA), global system for mobile (GSM) communications, worldwide interoperability for microwave access (WiMAX), or any other wireless standard. Through the network module 808, the TAM system 100 is able to communicate with other remote communication devices via an air interface.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

Also, techniques, systems, subsystems and methods described and illustrated in the various embodiments as discrete or separate may be combined or integrated with other systems, modules, techniques, or methods without departing from the scope of the present disclosure. Other products shown or discussed as directly coupled or communicating with each other may be coupled through some interface or device, such that the products may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

It should be understood that although an exemplary implementation of one embodiment of the present disclosure is illustrated above, the present system may be implemented using any number of techniques, whether currently known or in existence. The present disclosure should in no way be limited to the exemplary implementations, drawings, and techniques illustrated above, including the exemplary design and implementation illustrated and described herein, but may be modified within the scope of the appended claims along with their full scope of equivalents.

What is claimed is:

1. An asset allocation management system, comprising:
an asset located within an operational area; and
an asset management system in communication with the asset, the asset management system configured to determine that the asset has entered the operational area and the asset is capable of performing one or more requested services, wherein the asset management system obtains control of capabilities of the asset.

2. The system in accordance with claim 1 wherein the asset's capabilities include at least a one of the following: temperature awareness, include destination awareness, acceleration awareness, power awareness, time awareness or destination awareness.

3. The system in accordance with claim 1 wherein the operational area is defined by a plurality of points derived from a wireless network location determination

4. The system in accordance with claim 1 wherein the operational area is defined by a plurality of points derived from GPS information.

5. The system in accordance with claim 1 wherein the operational area is based upon proximity to a plurality of landmarks.

6. The system in accordance with claim 1 wherein the operational area is based upon proximity to a plurality of geographic regions.

7. The system in accordance with claim 1 wherein the operational area is based upon a plurality of locations sharing a common attribute.

8. A method for asset management, the method comprising:
determining that a plurality of assets are within the control of an operator, wherein at least one of the assets is not owned by the operator;
obtaining a request for a task that can be completed by at least one of the assets;
determining which of the plurality of assets are cable of performing the task;
selecting one of the determined asset(s) based upon at least one parameter; and
assigning the selected asset to perform the task.

9. The method in accordance with claim 8 wherein selecting one of the determined assets is based upon cost.

10. The method in accordance with claim 8 wherein selecting one of the determined assets is based upon asset capability.

11. The method in accordance with claim 10 wherein the asset capability includes at least a one of the following: temperature awareness, destination awareness, acceleration awareness, power awareness, time awareness, or destination awareness.

12. A method of visualizing assets, the method comprising:
registering a plurality of assets in a visual asset system;
identifying an operational task which can be satisfied using at least one of the plurality of assets;
determining a status of at least one of the plurality of the assets;
determining a class of at least one of the plurality of assets
selecting at least one of the plurality of the assets based upon the status and class of the at least one of the plurality of the assets which can complete the operational task; and
exerting control over the at least one of the plurality of the assets.

13. The method in accordance with claim 12 wherein the visual representation is displayed on at least one computer device.
